(19) United States
(12) Patent Application Publication
(10) Pub. No.: US 2007/0031226 A1
(43) Pub. Date: Feb. 8, 2007

(54) Trailer with platform assembly

(76) Inventor: Douglas Paul Hynes, Peoria, AZ (US)

Correspondence Address: MICHAEL WINFIELD GOLTRY, 4000 N. CENTRAL AVENUE, SUITE 1220, PHOENIX, AZ, 85012, US

(21) Appl. No.: 11/199,460

(22) Filed: Aug. 8, 2005

(51) Int. Cl. B60P 1/04

(52) U.S. Cl. 414/482

(57) ABSTRACT

A trailer includes a trailer bed, and a platform mounted to the trailer for pivotal movement at an elevated location relative to the bed between a raised position upright relative to the bed and a lowered position spaced from, opposing, and parallel relative to the bed forming a first storage space therebetween. In its lowered position the platform forms an auxiliary load-bearing bed above the trailer bed.

### FIELD OF THE INVENTION

The present invention relates to trailers and, more particular, to open, flatbed trailers.

### BACKGROUND OF THE INVENTION

There are many types of utility trailers. Some are general-purpose trailers are designed for carrying cargo. Such trailers typically have a box configuration, much like the bed of a pickup truck. There are also specialized trailers for towing sport and recreational vehicles, such as motorcycles, snowmobiles, and all-terrain vehicles (ATV's). Many of these are basic flatbed trailers that may also include stake pockets, and specialized hold-down hardware. While certain types of cargo may be carried by either a box trailer or a flatbed trailer, most flat-bed trailers cannot be used for many types of cargo. For example, sand, gravel, and other bulk granular materials cannot be effectively carried on a flatbed trailer. On the other hand, snowmobiles cannot generally be disposed transversely in the bed of a box trailer. Carrying in this manner requires a flatbed without sides.

Those of ordinary skill in the art will readily appreciate that convertible trailers of various kinds have been developed for accommodating various types of cargo. However, these usually involve removable side panels and other bulky parts that must be stored when not in use. Other convertible trailers involve complicated size or shape changing mechanisms that are costly and are difficult and expensive to maintain. Given these and other deficiencies in the art, the need for certain new and useful improvements is evident.

### SUMMARY OF THE INVENTION

It is an object of the invention to provide a trailer including a storage bed and that is configured with a platform assembly which is simple in structure, which is low in cost, which is safe, and in which it has platforms movable between upright positions relative to the storage bed and lowered positions spaced from and parallel to the storage bed each providing an auxiliary load-bearing bed above the storage bed for increasing the cargo loading and carrying capability of the trailer, in accordance with the principle of the invention.

According to the invention, there is provided a trailer including a bed, and a first platform mounted to the trailer for pivotal movement at an elevated location relative to the bed between a raised position upright relative to the bed and a lowered position spaced from, opposing, and parallel relative to the bed. In its lowered position the first platform forms a first auxiliary load-bearing bed spaced from and overlying the bed of the trailer. In another embodiment, a second platform is mounted to the trailer for pivotal movement at an elevated location relative to the bed between a raised position upright relative to the bed and a lowered position spaced from, opposing, and parallel relative to the bed. In its lowered position the second platform forms a second auxiliary load-bearing bed spaced from and overlying the bed of the trailer, wherein the second auxiliary load-bearing bed is different from the first auxiliary load-bearing bed. In their lowered positions the first and second platforms together form a third auxiliary load-bearing bed spaced from and overlying the bed of the trailer, which is greater in size than each of the first and second auxiliary load-bearing beds.

In one embodiment the third auxiliary load-bearing bed formed by the first and second platforms in their lowered positions extends longitudinally of the trailer substantially from the upstream end to the downstream end. In another embodiment the third auxiliary load-bearing bed formed by the first and second platforms in their lowered positions extends transversely of the trailer substantially from the first side to the second side.

A first latch is mounted to the trailer for securing the first platform in its raised position. A first abutment carried by the trailer for supporting the first platform in its lowered position. In yet another embodiment there is a first elongate support having a proximal end secured to the first platform and a distal end positioned against the bed in the lowered position of the first platform supporting the first platform in its lowered position. The first elongate support is pivotally secured to the first platform, and movable between a first position toward the first platform in its raised position and a second position away from first platform in its lowered position. A bias applied to the first elongate support biases the first elongate support toward its second position.

A second latch is mounted to one of the second platform and the trailer for supporting the second platform in its raised position. A second abutment is carried by one of the first platform and the trailer for supporting the second platform in its lowered position. In yet another embodiment there is a second elongate support having a proximal end secured to the second platform and a distal end positioned against the bed in the lowered position of the second platform supporting the second platform in its lowered position. The first elongate support is pivotally secured to the first platform, and movable between a first position toward the first platform in its raised position and a second position away from first platform in its lowered position. A bias applied to the second elongate support biases the second elongate support toward its second position.

Consistent with the foregoing summary of preferred embodiments, and the ensuing detailed description, which are to be taken together, the invention also contemplates associated embodiments.

### BRIEF DESCRIPTION OF THE DRAWINGS

Referring to the drawings:

FIG. 1 is an exploded perspective view of a trailer and a platform assembly disposed above the trailer and constructed and arranged in accordance with the principle of the invention;

FIG. 2 is a perspective view of the platform assembly shown as it would appear secured to the trailer forming an embodiment constructed and arranged in accordance with the principle of the invention;

FIG. 3 is a perspective view of the trailer of FIG. 2 showing platforms of the platform assembly disposed in raised positions;

FIG. 4 is a perspective view of the trailer of FIG. 2 with one pair of platforms of the platform assembly shown in a lowered position and another pair of platforms of the platform assembly shown in a raised position;

FIG. 5 is a perspective view of the trailer of FIG. 2 with one pair of platforms of the platform assembly shown in a lowered position and another pair of platforms of the platform assembly shown in a raised position;

FIG. 6 is perspective view of the trailer of FIG. 2 with platforms of the platform assembly shown in lowered positions and ramps fitted onto a side of the platform assembly;

FIG. 7 is a fragmented perspective view of the trailer of FIG. 2 with platforms of the platform assembly shown in lowered positions, in which the platforms are each formed with an elongate support having a proximal end secured thereto and an opposing distal end positioned against the bed of the trailer;

FIG. 8 is a fragmented perspective view of one of the platforms of the platform assembly of FIG. 2 depicted as it would appear in a raised position with an elongate support attached thereto;

FIG. 9 is a side elevational view of an alternate embodiment of an elongate support for use with a platform assembly constructed and arranged in accordance with the principle of the invention;

FIG. 10 is a fragmented perspective view of a proximal end of the elongate support of FIG. 9;

FIG. 11 is a fragmented perspective view of a distal end of the elongate support of FIG. 9;

FIG. 12 is a fragmented perspective view of the trailer of FIG. 2 showing a portion of a framework of the platform assembly;

FIG. 13 is a fragmented perspective view of the platform assembly of FIG. 1 showing a latch securing one of the platforms thereof;

FIG. 14 is a fragmented perspective view of the platform assembly of FIG. 1 showing a latch securing one of the platforms thereof;

FIG. 15 is a fragmented perspective view of the platform assembly of FIG. 1 showing a ramp locking latch securing ramps;

FIG. 16 is a fragmented top plan view of a side of the platform assembly of FIG. 1;

FIG. 17 is a perspective view of a side of the platform assembly of FIG. 1; and

FIG. 18 is a perspective view of handles each affixed to a platform of the platform assembly of FIG. 1.

### DETAILED DESCRIPTION OF PREFERRED EMBODIMENTS

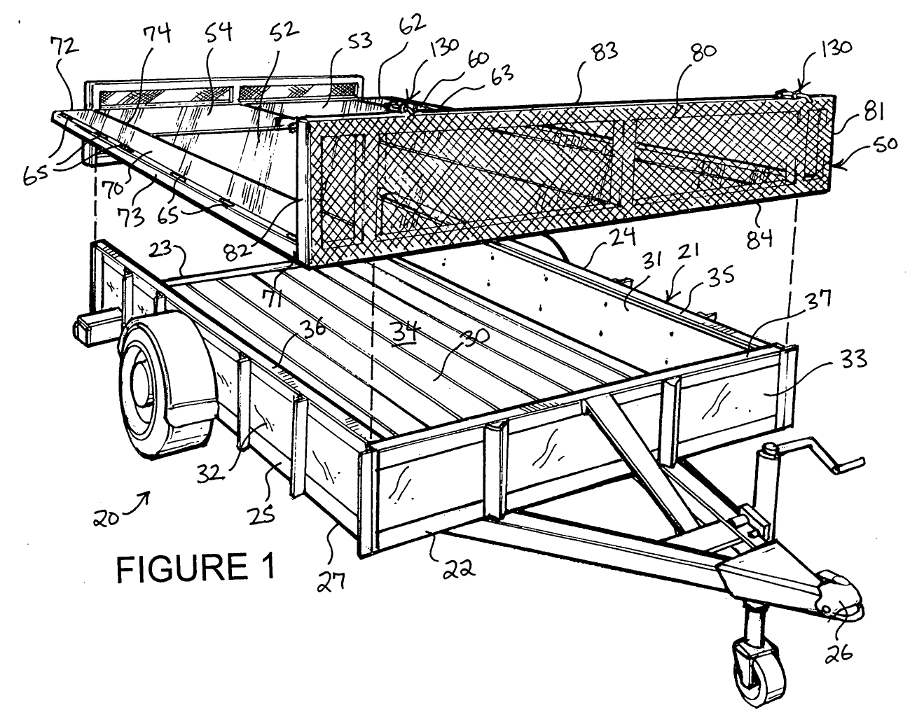

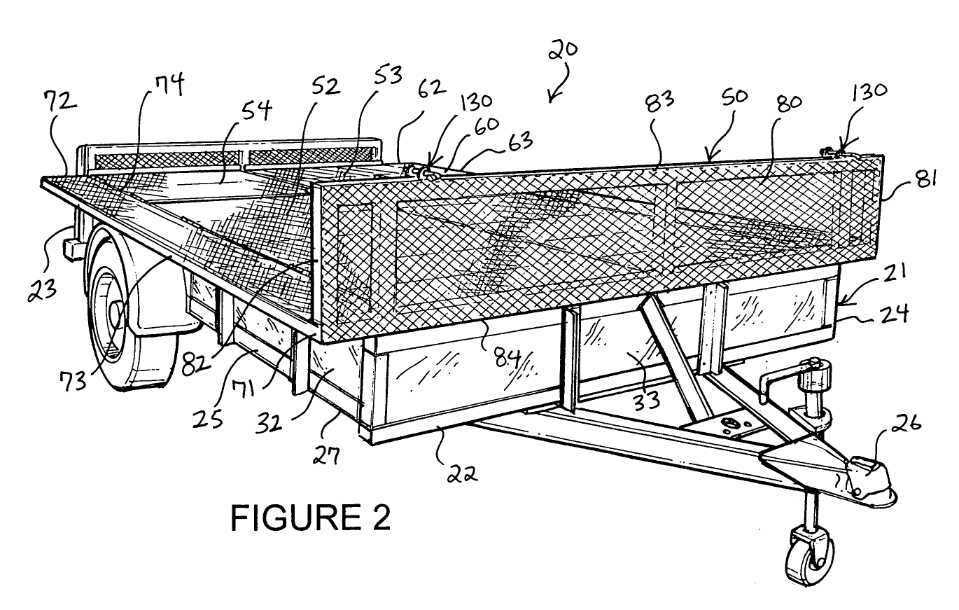

Turning now to the drawings, in which like reference characters indicate corresponding elements throughout the several views, attention is first directed in relevant part to FIGS. 1 and 2 in which there is seen a trailer 20 including a wheeled chassis/body 21 having opposing upstream and downstream ends 22 and 23, opposing sides 24 and 25, and a hitch assembly 26, for lifting and towing and for connecting trailer 20 to a motor vehicle such as an automobile (not shown), attached to and projecting forwardly of upstream end 22. Body 21 includes of a frame 27 made of strong metal, such as steel or aluminum, and is furnished with one or more attached axles to which wheels are attached in a conventional manner for permitting its wheeled movement. In the immediate embodiment, trailer 20 incorporates two wheels, one on each side, and less or more can be used depending on specific user requirements. Paneling, considered part of body 21, such as wood paneling, plastic paneling, aluminum paneling, steel paneling, fiberglass paneling, or the like, is attached to frame 27 of trailer 20 forming a bed 30, opposing parallel sidewalls 31 and 32, and a front wall 33, which together define a storage area 34. Sidewalls 31 and 32 project upwardly of bed 30 at sides 24 and 25, respectively, and front wall 33 projects upwardly of bed 30 at upstream end 22. Sidewalls 31 and 32 terminate upwardly of bed 30 with upper edges/sides 35 and 36, respectively, and front wall 33 terminates upwardly of bed 30 with an upper edge/side 37. Sides 35, 36, and 37, reside in a generally horizontal plane parallel to bed 30.r

Looking to FIG. 1, a platform assembly 50 is shown, which is constructed and arranged in accordance with the principle of the invention and which is shown detached from trailer 20 overlying it opposing and confronting bed 30. Platform assembly 50 is adapted to be attached to trailer 20, and FIG. 2 shows trailer 20 as it would appear having platform assembly 50 attached thereto. Platform assembly 50 can be prefabricated as a unit and then attached to trailer 20, such as by welding, with brackets, with screws, rivets, nut-and-bolt assemblies or other form of mechanical fasteners, or constructed concurrently with the construction of trailer 20. When attached to trailer 20, platform 50 is considered part of trailer 20, in accordance with the principle of the invention.

Platform assembly 50 is fashioned of a series of large, flat, rigid panels or platforms, which are constructed of steel, aluminum, or other rigid, strong material or combination of materials and are each a structural support component of platform assembly 50. In this particular embodiment, each platform is fashioned of paneling rigidly secured to a frame made of strong metal, such as steel or aluminum. The paneling in a preferred embodiment is metallic mesh paneling, which is fastened to its corresponding frame with welding, rivets, metal screws, nut-and-bolt assemblies, or the like. As long as the platforms used to form platform assembly 50 are strong, rigid and suitable for accommodating relative large loads and cargo, the platforms can be fashioned in different ways, and may even be integrally formed of rigid and relatively thick sheet stock formed of steel, aluminum, carbon fiber, fiberglass, etc. If desired, the metallic mesh paneling used in the immediate embodiment can be replaced with solid sheet stock. Accordingly, the term “platform” used to describe the various components of platform assembly 50 is intended to denote a large, rigid, strong, relatively flat structural component constructed and arranged in accordance with this discussion, and the specific structural details of each platform of platform assembly 50 will, therefore, not be discussed separately in detail.

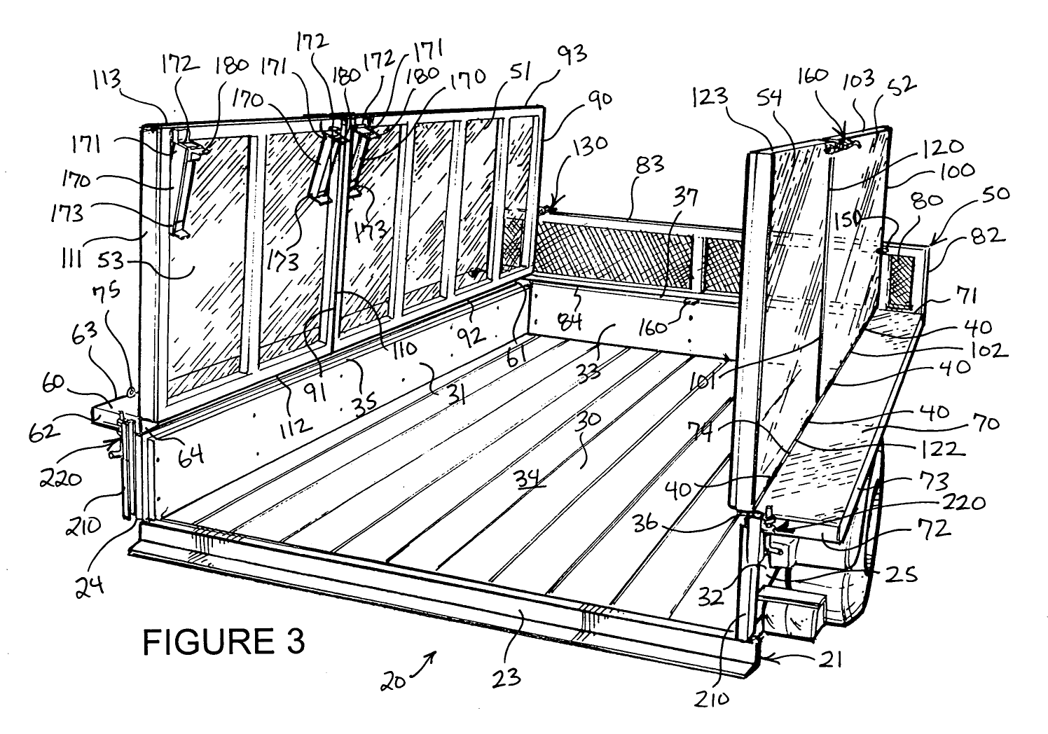

Referring to FIGS. 3-6 in relevant part, platform assembly 50 consists of platforms 51, 52, 53, and 54 pivotally attached to a supporting base 55 with hinges. Base 55 consists of opposing, parallel side platforms 60 and 70 an upstream platform 80. Side platforms 60 and 70 are substantially equal in size and identical in structure. Side platform 60 is long and rectangular in shape and has opposing front and rear ends 61 and 62 and opposing outer and inner sides 63 and 64. Side platform 70 is also long and rectangular in shape and has opposing front and rear ends 71 and 72 and opposing outer and inner sides 73 and 74. Upstream platform 80 is, like side platforms 60 and 70, long and rectangular in shape and has opposing ends 81 and 82 and opposing upper and lower sides 83 and 84.

Side platform 60 is situated at side 24 of trailer 20, side platform 70 is situated at side 25 of trailer 20, and upstream platform 80 is situated at upstream end 22 of trailer 20. Side platform 60 extends along the entire length of trailer 20 at side 24 from upstream end 22 to downstream end 23, and its inner side 64 is rigidly affixed to upper edge 35 of sidewall 31, such as by welding, screws, nut-and-bolt assemblies, or the like suitable for providing a rigid and rugged attachment of inner side 64 of side platform 60 to upper edge 35 of sidewall 31. Side platform 70 extends along the entire length of trailer 20 at side 25 from upstream end 22 to downstream end 23, and its inner side 74 is rigidly affixed to upper edge 36 of sidewall 32, such as by welding, screws, nut-and-bolt assemblies, or the like suitable for providing a rigid and rugged attachment of inner side 74 of side platform 70 to upper edge 36 of sidewall 32. Upstream platform 80 extends along the entire width of trailer 20 at upstream end 22 from side 24 to side 25, and its lower side 84 is rigidly affixed to upper edge 37 of front wall 33, such as by welding, screws, nut-and-bolt assemblies, or the like suitable for providing a rigid and rugged attachment of lower side 84 of upstream platform 80 to upper edge 37 of front wall 33.

So mounted to trailer 20, upstream platform 80 is disposed at upstream end 22 of trailer 20, and side platforms 60 and 70 are disposed at sides 24 and 25, respectively, of trailer 20. Platforms 60, 70, and 80 are each disposed at each at an elevated location relative to bed 30. Side platforms 60 and 70 and are each disposed in a horizontal attitude onto which cargo may be placed for transport.

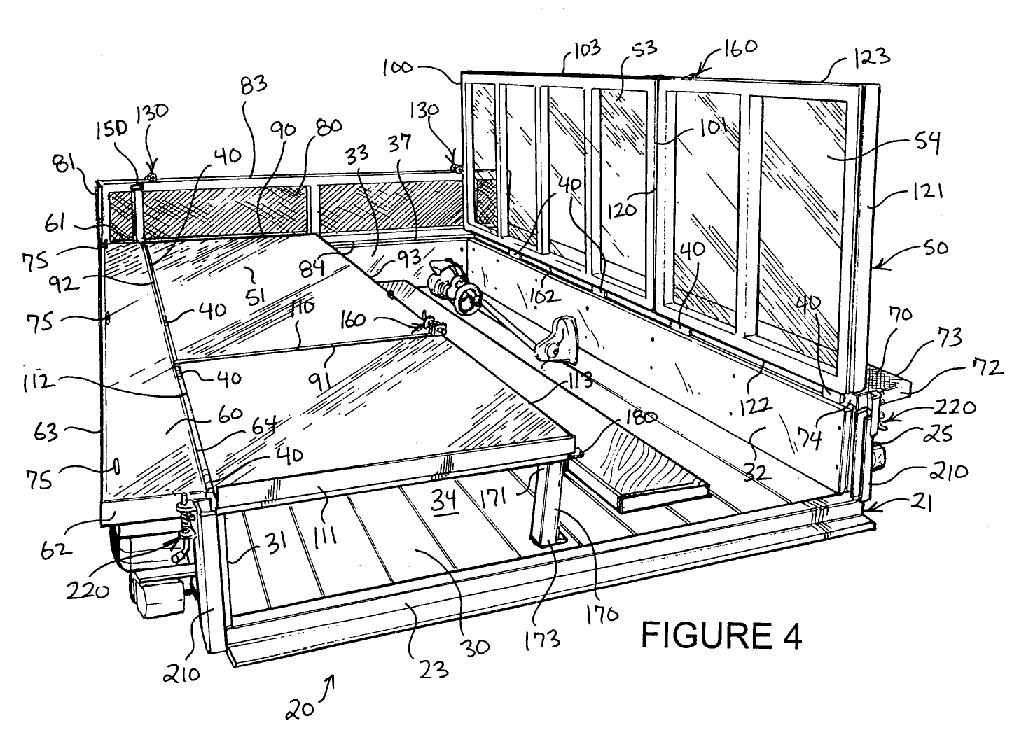

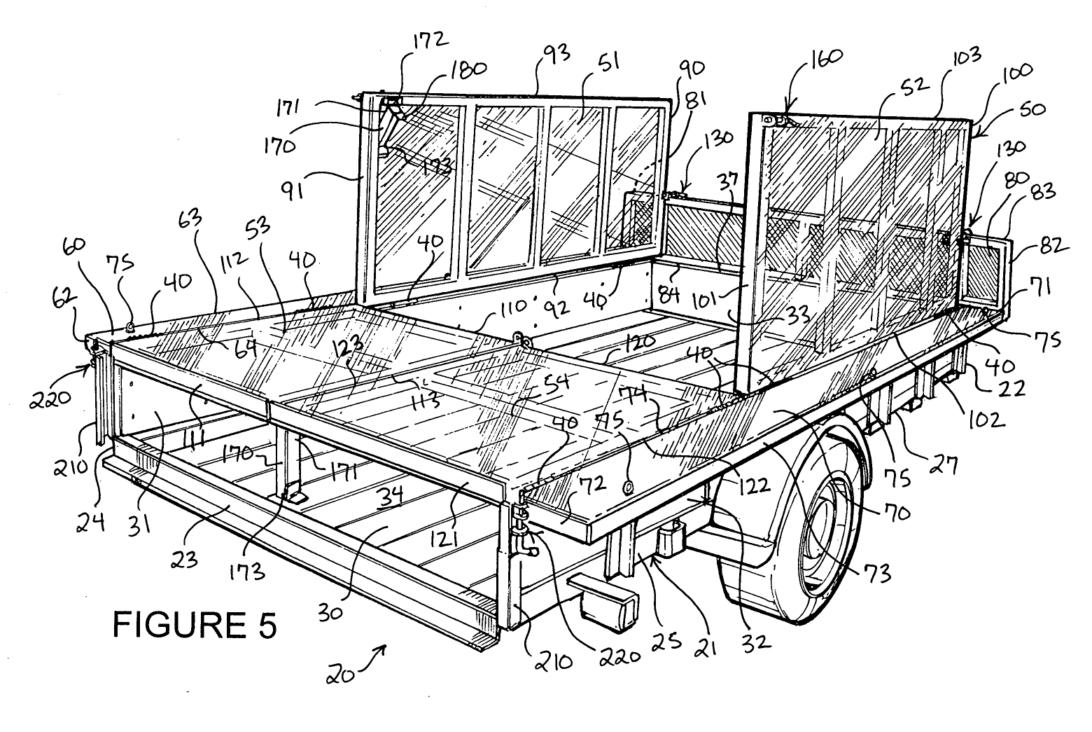

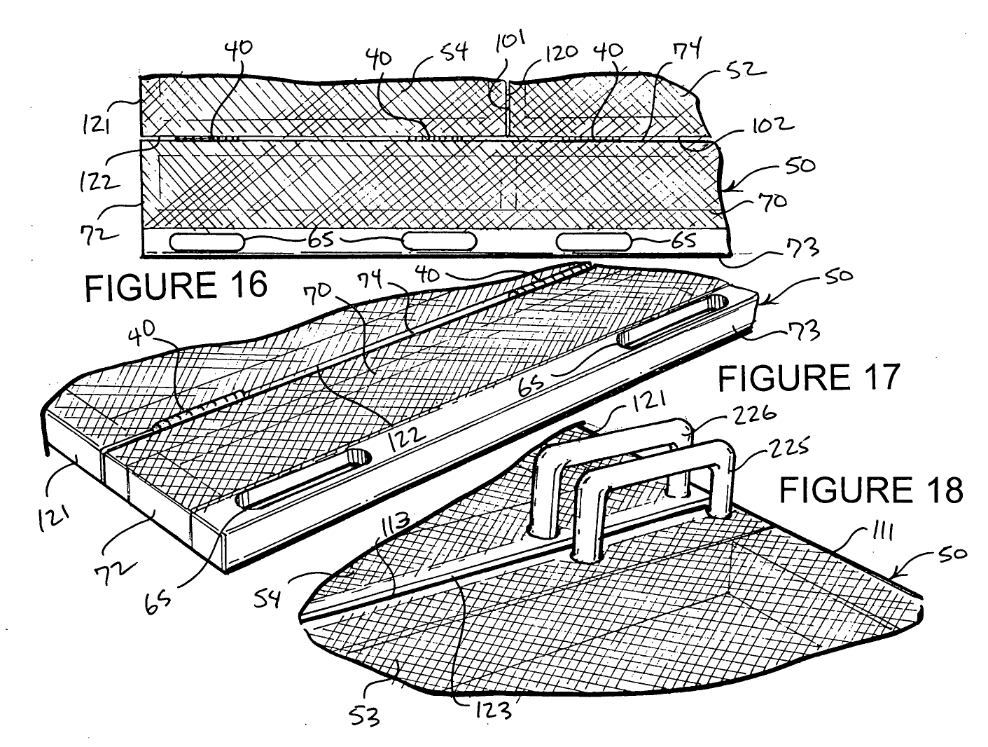

Side platforms 60 and 70 preferably incorporate specialized hold-down or tie-down hardware or features that may be used for securing ropes and other forms of cordage for tying down cargo placed thereon. In FIG. 1, side platform 60 is formed with tie-down features consisting of openings 65 therethrough disposed at spaced intervals along outer side 63 through which ropes and other tie-down cordage can be passed and used to tie down cargo set onto side platform 60. FIG. 16 is a fragmented top plan view of side platform 60 showing openings 65 therethrough, and FIG. 17 is a perspective view of side platform 60 showing openings 65 therethrough. Side platform 70 can be similarly configured with such tie-down openings. In FIGS. 4 and 5, side platform 70 is formed with tie-down features consisting of attached, upstanding eyelets 75 disposed at spaced intervals along outer side 73 through which ropes and other tie-down cordage can be passed and used to tie down cargo set onto side platform 70. Side platform 60 can be similarly configured with such eyelets 75, and this is shown in FIG. 5. Those having regard for the art will readily appreciate that side platforms 60 and 70, may be configured with any suitable form of hold-down or tie-down hardware or features for securing cargo.

Side platforms 60 and 70 are parallel relative to one another, in which their inner sides 64 and 74 face storage area 34 and their outer sides 63 and 73 project outwardly away from sides 24 and 25, respectively, of trailer 20. Front ends 61 and 71 of side platforms 60 and 70 meet ends 81 and 82, respectively, of front wall 80 and are rigidly affixed to ends 81 and 82, respectively, such as by welding, screws, nut-and-bolt assemblies, or the like suitable for providing a rigid and rugged attachment of front ends 61 and 71 of side platforms 60 and 70 to ends 81 and 82, respectively, of upstream platform 80. Upstream platform 80 resides in the same vertical plane as front wall 33, and is upright extending upwardly from its lower side 84 to its upper side 83 constituting an extension of front wall 33.

Platforms 51, 52, 53, and 54 will now be discussed, one by one. Platforms 51 and 52 are substantially equal in size and structure, oppose one another and are situated toward upstream platform 80 at upstream end 22 of trailer 20. Platform 51 is further situated toward side 24 of trailer 20, and platform 52 is further situated toward side 25 of trailer 20. Platforms 53 and 54 are substantially equal in size and structure, oppose one another and are situated toward downstream end 22 of trailer 20. Platform 52 is further situated toward side 24 of trailer 20, and platform 54 is further situated toward side 25 of trailer 20. In this particular embodiment the size of each of platforms 51 and 52 is greater than the size of each of platforms 53 and 54, and this is shown as a matter of example with the understanding that this aspect may be reversed, in which platforms 51 and 52 may each be lesser in size than each of platforms 53 and 54. If desired, panels 51, 52, 53, and 54 may each be equal in size, or differently sized, consistent with the teachings provided herein.

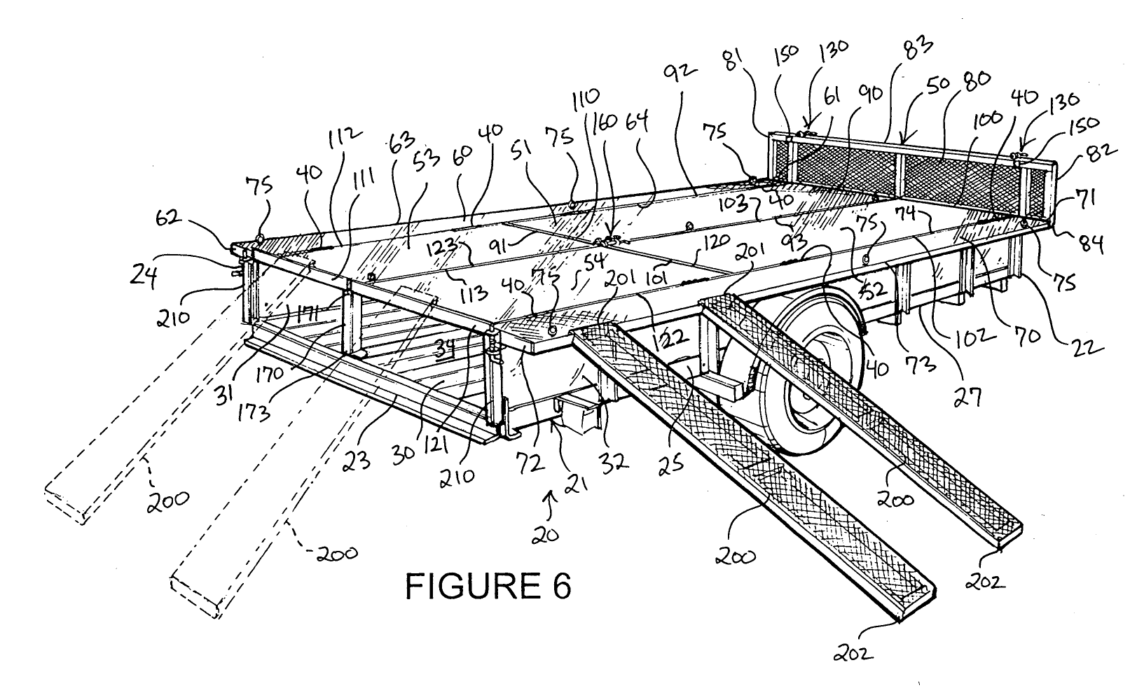

Platform 51 is rectangular in shape and has opposing front and rear ends 90 and 91 and opposing inner and outer sides 92 and 93. Inner side 92 of platform 51 is pivotally mounted to inner side 64 of side platform 60 with hinges 40. Because inner side 64 of side platform 60 is disposed at an elevated location relative to bed 30 and that inner side 92 of platform 51 is pivotally mounted to inner side 64 of side platform 60 with hinges 40, platform 51 is considered mounted for pivotal movement at an elevated location relative to bed 30. Platform 51 pivots between a raised position (FIGS. 3 and 5) upright relative to bed 30 and a lowered position (FIGS. 4 and 6) spaced from, opposing, and parallel relative to bed 30 forming a storage space therebetween.

Platform 52 is, like platform 51, rectangular in shape and has opposing front and rear ends 100 and 101 and opposing inner and outer sides 102 and 103. Inner side 102 of platform 52 is pivotally mounted to inner side 74 of side platform 70 with hinges 40. Because inner side 74 of side platform 70 is disposed at an elevated location relative to bed 30 and that inner side 102 of platform 52 is pivotally mounted to inner side 74 of side platform 70 with hinges 40, platform 52 is considered mounted for pivotal movement at an elevated location relative to bed 30. Platform 52 pivots between a raised position (FIGS. 3-5) upright relative to bed 30 and a lowered position (FIG. 6) spaced from, opposing, and parallel relative to bed 30 forming a storage space therebetween.

In their raised/upright positions and shown in FIGS. 3 and 5, platforms 51 and 52 oppose and are substantially parallel relative to one another essentially forming extensions of sidewalls 31 and 32, respectively, toward upstream end 22 of trailer 20 thus increasing the height of storage area 34 allowing more cargo to be contained therein between platforms 51 and 52, in accordance with the principle of the invention. In their raised/upright positions, platforms 51 and 52 extend upwardly from upper edges 35 and 36 of sidewalls 31 and 32, respectively, essentially constituting sidewall extensions of sidewalls 31 and 32, respectively, toward upstream end 22 of trailer 20.

In its lowered position, platform 51 forms an auxiliary load-bearing bed situated above bed 30 proximate upstream end 22 of trailer 20 at side 24, which is able to accommodate thereon cargo increasing the cargo-holding capacity of trailer 20, and in which the storage space between platform 51 and bed 30 is also available to accommodate cargo. In its lowered position, platform 52 also forms an auxiliary load-bearing bed situated above bed 30 proximate upstream end 22 of trailer 20 at side 25, which is able to accommodate thereon cargo increasing the cargo-holding capacity of trailer 20, and in which the storage space between platform 51 and bed 30 is also available to accommodate cargo.

In their lowered positions, platforms 51 and 52 meet at their outer sides 93 and 94 as shown in FIG. 6 and cooperate forming a major auxiliary load-bearing bed situated above bed 30 toward upstream end 22 of trailer 20, which extends laterally of trailer 20 from side 24 to side 25 proximate upstream end 22 of trailer 20 and which is able to accommodate thereon cargo increasing the cargo-holding capacity of trailer 20, and in which the storage spaces between platforms 51 and 52 and bed 30 are also available to accommodate cargo. Because the major auxiliary load-bearing bed is the two auxiliary load-bearing beds of platforms 51 and 52 combined, the major auxiliary load-bearing bed is substantially greater than each of the auxiliary load-bearing beds defined by platforms 51 and 52, respectively.

Platform 53 is square in shape and has opposing front and rear ends 110 and 111 and opposing inner and outer sides 112 and 113. Inner side 112 of platform 53 is pivotally mounted to inner side 64 of side platform 60 with hinges 40. Because inner side 64 of side platform 60 is disposed at an elevated location relative to bed 30 and that inner side 112 of platform 53 is pivotally mounted to inner side 64 of side platform 60 with hinges 40, platform 53 is considered mounted for pivotal movement at an elevated location relative to bed 30. Platform 53 pivots between a raised position (FIG. 3) upright relative to bed 30 and a lowered position (FIGS. 4-6) spaced from, opposing, and parallel relative to bed 30 forming a storage space therebetween.

Platform 54 is, like platform 53, square in shape and has opposing front and rear ends 120 and 121 and opposing inner and outer sides 122 and 123. Inner side 122 of platform 54 is pivotally mounted to inner side 74 of side platform 70 with hinges 40. Because inner side 74 of side platform 70 is disposed at an elevated location relative to bed 30 and that inner side 122 of platform 54 is pivotally mounted to inner side 74 of side platform 70 with hinges 40, platform 54 is considered mounted for pivotal movement at an elevated location relative to bed 30. Platform 54 pivots between a raised position (FIGS. 3 and 4) upright relative to bed 30 and a lowered position (FIGS. 5 and 6) spaced from, opposing, and parallel relative to bed 30 forming a storage space therebetween.

In their raised/upright positions and shown in FIG. 3, platforms 53 and 54 oppose and are substantially parallel relative to one another essentially forming extensions of sidewalls 31 and 32, respectively, toward downstream end 23 of trailer 20 thus increasing the height of storage area 34 allowing more cargo to be contained therein between platforms 53 and 54, in accordance with the principle of the invention. In their raised/upright positions, platforms 53 and 54 extend upwardly from upper edges 35 and 36 of sidewalls 31 and 32, respectively, essentially constituting sidewall extensions of sidewalls 31 and 32, respectively, toward downstream end 23 of trailer 20.

In its lowered position, platform 53 forms an auxiliary load-bearing bed situated above bed 30 proximate downstream end 23 of trailer 20 at side 24, which is able to accommodate thereon cargo increasing the cargo-holding capacity of trailer 20, and in which the storage space between platform 53 and bed 30 is also available to accommodate cargo. In its lowered position, platform 54 also forms an auxiliary load-bearing bed situated above bed 30 proximate downstream end 23 of trailer 20 at side 25, which is able to accommodate thereon cargo increasing the cargo-holding capacity of trailer 20, and in which the storage space between platform 53 and bed 30 is also available to accommodate cargo.

In their lowered positions, platforms 53 and 54 meet at their outer sides 113 and 123 as shown in FIGS. 5 and 6 and cooperate forming a major auxiliary load-bearing bed situated above bed 30 toward downstream end 23 of trailer 20, which extends laterally of trailer 20 from side 24 to side 25 proximate downstream end 23 of trailer 20 and which is able to accommodate thereon cargo increasing the cargo-holding capacity of trailer 20, and in which the storage spaces between platforms 53 and 54 and bed 30 are also available to accommodate cargo. Because the major auxiliary load-bearing bed is the two auxiliary load-bearing beds of platforms 53 and 54 combined, the major auxiliary load-bearing bed is substantially greater than each of the auxiliary load-bearing beds defined by platforms 53 and 54, respectively.

As will be presently explained, platform 51 can be disposed in its raised position and its lowered position independent of platforms 52, 53, and 54, platform 52 can disposed in its raised position and its lowered position independent of platforms 51, 53, and 54, platform 53 can disposed in its lowered position independent of platforms 51, 52, and 54, and platform 54 can disposed in its lowered position independent of platforms 51, 52, and 53. As will be presently discussed, trailer 20 can, if desired, be configured so that platform 53 can be disposed in its raised position independent of platforms 51, 52, and 54, and so that platform 54 can be disposed in its raised position independent of platforms 51, 52, and 53. The ability to configure trailer 20 in these different cargo holding configurations provides tremendous flexibility for storing and transporting cargo.

Platform assembly 50 incorporates latches 130, which are shown in FIGS. 1, 2, and 4-6, and latches 160, which are shown in FIGS. 3-6. Latches 130 are used to secure platforms 51 and 52 in their raised positions, respectively. Latches 160 are used to secure platforms together 51 and 53, and platforms 52 and 54 together, respectively. Latches 130 and 160 are identical and only one will be discussed with the understanding that the ensuing discussion applies to each of latches 130 and 160.

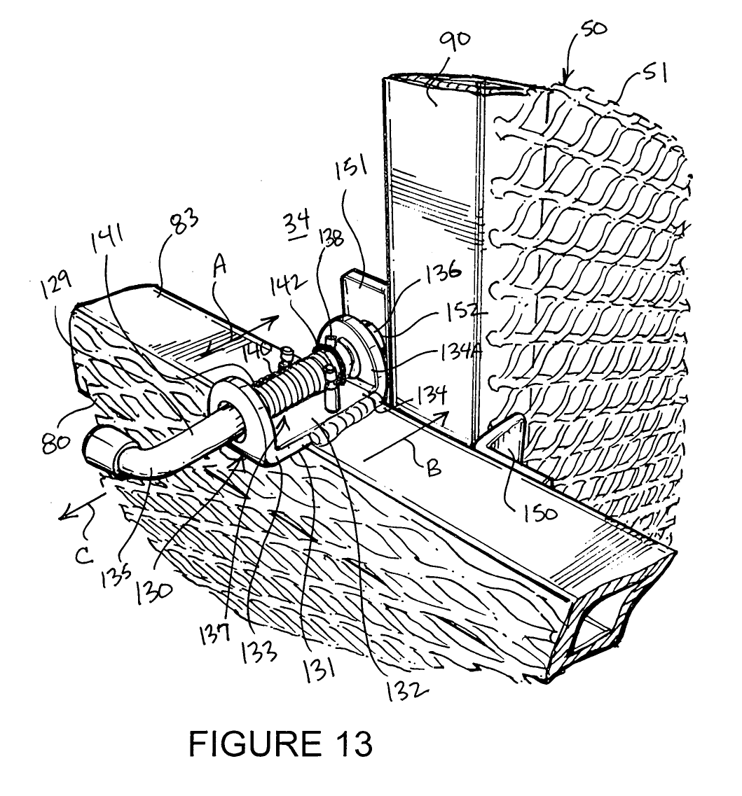

Looking to FIG. 13, latch 130 consists of a pin 129 mounted to a bracket 132 for reciprocal movement as indicated by the double arrowed line A. Bracket 131 consists of a base 132, having opposing ends 133 and 134, rigidly secured to upper side 83 of upstream panel 80 at a location proximate and yet inboard of end 81 as best seen in FIG. 2. Base 132 is rigidly affixed to upper side 83 of upstream platform 80 with welding, although it can be rigidly affixed in place in other ways, such as with one or more rivets, screws, nut-and-bolt assemblies, etc.

Ends 133 and 134 are formed with opposing upstanding tags 133A and 134A having openings therethrough through which pin 129 extends. Tag 133A is directed upstream away from storage area 34, and tag 134A is directed downstream toward storage area 34. Pin 129 has a proximal end 135 disposed outboard of tag 133A and which is the handled end of pin 129, an opposing distal end 136 disposed outboard of tab 134B, and an intermediate portion 137 therebetween positioned between tags 133A and 134A. Intermediate portion 137 is formed with an outwardly projecting abutment 138 disposed toward tag 134A.

A compression spring 140 includes a wire formed into coils encircling intermediate portion 137. Compression spring 140 has opposed flanged ends 141 and 142 and is captured onto intermediate portion 137 between tag 133A, against which flanged end 141 is received, and abutment 138, against which flanged end 142 is received. Spring 140 biases pin 129 in the direction indicated by the arrowed line B, which, for orientation purposes, is toward storage area 34. Proximal end 135 may be taken up by hand and pulled away from storage area 34 in the direction indicated by the arrowed line C with a force sufficient to overcome the bias applied to pin 129 by spring 140 for moving pin 140 in a forward or cocked position away from storage area 34. When proximal end 135 of pin 129 is released, compression spring 140 acts on tag 133A and abutment 138 moving pin 129 inwardly toward storage area 34 from its cocked position into its deployed position.

Upper side 83 of upstream platform 80 is formed with an inwardly directed stop 150 against which platform 51 rests when disposed in its raised position. Stop 150 limits the pivotal movement of platform 51 beyond stop 150. Front end 90 of platform 51 is formed with an inwardly directed support 151, which is considered part of platform 51. Support 151 has an opening 152 therethrough that aligns with distal end 136 of pin 129 in the raised position of platform 51 when pin 129 is disposed in its cocked position. Upon aligning the opening through support 151 with distal end 136 of pin 129 while in its cocked position, pin 129 may be released snapping pin 129 rearwardly toward storage area 34 into its deployed position inserting distal end 136 of pin into and through the opening through support 151 securing/pinning platform 51 in its raised position, in accordance with the principle of the invention. Reversing this operation releases platform 51 allowing it to be pivoted from its raised position to its lowered position.

Opening 152 can be formed directly into platform 51 rather than to a support secured thereto. However, because support 151 is secured to platform 51, it is considered part of platform 51. Although latch 130 including pin 129 and bracket 131 are carried by upstream platform 8, and support 151 is carried by platform 51, this can be reversed. As previously explained, the latch 130 attached to upstream platform 80 proximate end 82 functions with platform 52 identically to the way in which latch 130 functions with platform 51 and is operative for securing platform 52 in its raised position.

When platforms 51 and 53 are placed in their raised positions as seen in FIG. 3, rear end 91 of platform 51 meets front end 110 of platform 53. This also applies when platforms 51 and 53 are placed in their lowered positions as shown in FIG. 4. When platforms 52 and 54 are placed in their raised positions as seen in FIG. 4, rear end 101 of platform 52 meets front end 120 of platform 54. This also applies when platforms 52 and 54 are placed in their lowered positions as shown in FIG. 6.

In their lowered positions, platforms 51 and 53 meet at their rear and front sides 91 and 110, respectively, and cooperate forming a major auxiliary load-bearing bed situated above bed 30 toward side 24 of trailer 20, which extends longitudinally of trailer 20 from upstream end 22 of trailer 20 to downstream end 23 of trailer 20 and which is able to accommodate thereon cargo increasing the cargo-holding capacity of trailer 20, and in which the storage spaces between platforms 51 and 53 and bed 30 are also available to accommodate cargo. Because the major auxiliary load-bearing bed is the two auxiliary load-bearing beds of platforms 51 and 53 combined, the major auxiliary load-bearing bed is substantially greater than each of the auxiliary load-bearing beds defined by platforms 51 and 53, respectively.

In their lowered positions, platforms 52 and 54 meet at their rear and front sides 101 and 120, respectively, and cooperate forming a major auxiliary load-bearing bed situated above bed 30 toward side 25 of trailer 20, which extends longitudinally of trailer 20 from upstream end 22 of trailer 20 to downstream end 23 of trailer 20 and which is able to accommodate thereon cargo increasing the cargo-holding capacity of trailer 20, and in which the storage spaces between platforms 52 and 54 and bed 30 are also available to accommodate cargo. Because the major auxiliary load-bearing bed is the two auxiliary load-bearing beds of platforms 52 and 54 combined, the major auxiliary load-bearing bed is substantially greater than each of the auxiliary load-bearing beds defined by platforms 52 and 54, respectively.

Latches 160 are used to secure platforms together 51 and 53, and platforms 52 and 54 together, respectively, as previously explained. When rear end 91 of platform 51 and front end 110 of platform 53 meet, whether in the concurrent raised positions of platforms 51 and 53 or the concurrent lowered positions of platforms 51 and 53, the latch incorporated with platforms 51 and 53 may be used to secure rear end 91 of platform 51 to front end 110 of platform 53. Similarly, when platforms 52 and 54 are placed in their raised positions as seen in FIGS. 3 and 4, rear end 101 of platform 52 meets front end 120 of platform 54. This also applies when platforms 52 and 54 are placed in their lowered positions as shown in FIG. 6. When rear end 101 of platform 52 and front end 120 of platform 54 meet, whether in the concurrent raised positions of platforms 52 and 54 or the concurrent lowered positions of platforms 52 and 54, the latch 160 incorporated with platforms 52 and 54 may be used to secure rear end 101 of platform 52 to front end 120 of platform 54.

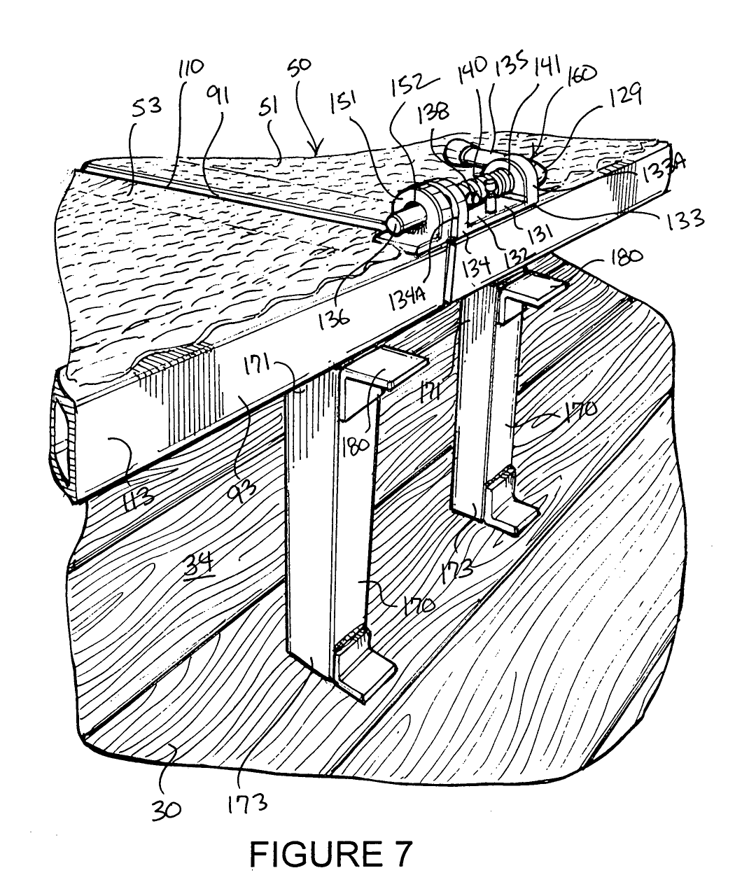

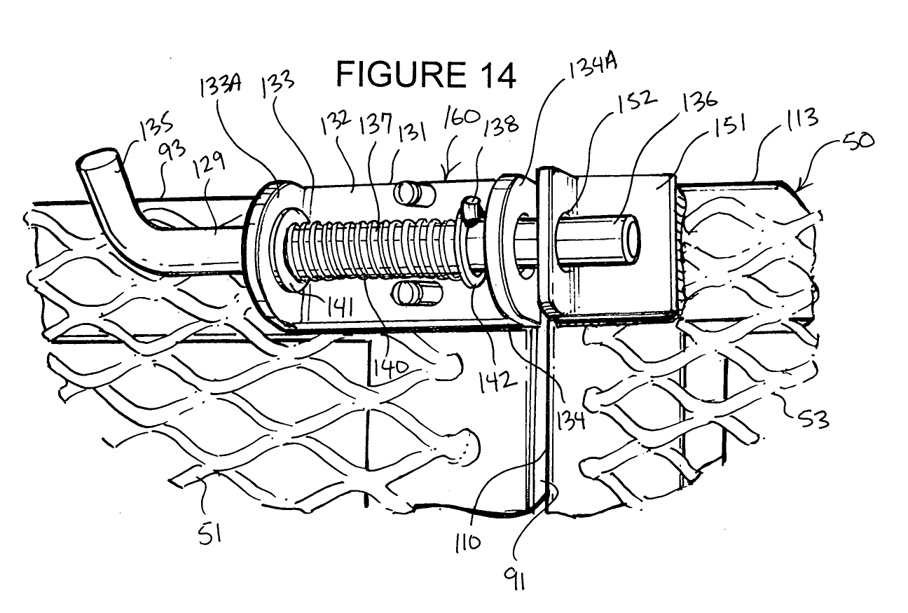

FIG. 14 shows rear end 91 of platform 51 meeting front end 110 of platform 53, and latch 160 incorporated therewith securing platform 51 to platform 53. FIG. 7 shows platforms 51 and 53 in their lowered positions with rear end 91 of platform 51 meeting front end 110 of platform 53, and latch 160 incorporated therewith securing platform 51 to platform 53. Latch 160 is completely analogous to latch 130. In common with latch 130 previously discussed, latch 160 incorporated with platforms 51 and 53 in FIGS. 7 and 14 shares bracket 131, pin 129 including its proximal and distal ends 135 and 136 and its intermediate portion 137 (not shown in FIG. 7) formed with abutment 138, spring 140 including its flanged ends 141 and 142, and support 151 including opening 152 therethrough that aligns with distal end 136 of pin 129 when rear end 91 of platform 51 meets front end 110 of platform 53 when pin 129 is disposed in its cocked position. Upon aligning the opening through support 151 with distal end 136 of pin 129 while in its cocked position, pin 129 may be released snapping pin 129 rearwardly into its deployed position inserting distal end 136 of pin into and through the opening through support 151 affixed to platform 53 securing/pinning platform 51 to platform 53. Reversing this operation releases platform 51 allowing it to be pivoted from its raised position to its lowered position.

In the preferred embodiment disclosed herein, bracket 131, to which pin 129 is attached, of latch 160 is secured to outer end 93 of platform 51 at its rear end 91, and support 151 is secured to outer end 113 of platform 53 at its forward end 110, and this arrangement can be reversed, if desired. It is to be understood that bracket 160 can be incorporated with platforms 51 and 53 at other locations provided it functions in accordance with the teachings provided herein.

The latch 160 incorporated with platforms 52 and 54 is structurally and functionally identical to latch 160 incorporated with platforms 51 and 53, and it is to be understood that the foregoing discussion of latch 160 in conjunction with platforms 51 and 53 applies to latch 160 in conjunction with platforms 52 and 54. In the preferred embodiment disclosed herein, bracket 131, to which pin 129 is attached, of latch 160 is secured to outer end 103 of platform 52 at its rear end 101, and support 151 is secured to outer end 123 of platform 54 at its forward end 120, and this arrangement can be reversed, if desired. It is to be understood that bracket 160 can be incorporated with platforms 52 and 54 at other locations provided it functions in accordance with the teachings provided herein.

Although platforms 51 and 52 each incorporate one bracket 130, more can be provided, if desired. Although platforms 51 and 53 incorporate one bracket 160, more can be provided, if desired, which is also the case with platforms 52 and 54.

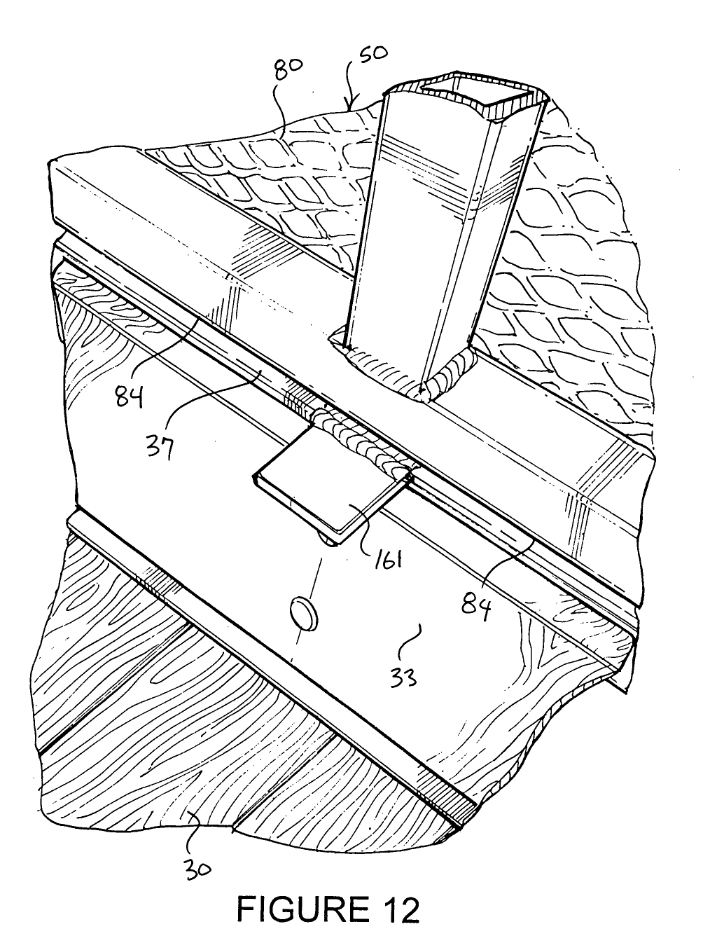

The invention incorporates structure that functions to dispose and support platforms 51, 52, 53, and 54 in their lowered positions, and for imparting structural support to platforms 51, 52, 53, and 54 in their lowered positions. In one embodiment as shown in FIGS. 3 and 12, upper edge 37 of front wall 33 is formed with an inwardly directed abutment 161 against which outer side 93 of platform 51 at front end 90 comes to rest against when platform 51 is laid into its lowered position. Although abutment 161 is formed with trailer, it can be formed with lower side 84 of upstream platform 80 if desired. Also, although only one abutment 161 is shown, more can be provided if desired. One or more similar abutments can be incorporated to work in conjunction with platform 52, if desired. However, it is to be understood that in this embodiment abutment 161 is sufficiently sized and positioned specifically to provide support for platform 52 when in its lowered position. In this regard, and similar to platform 51, it is to be understood that outer side 103 of platform 52 at front end 100 comes to rest against abutment 161 when platform 52 is laid into its lowered position.

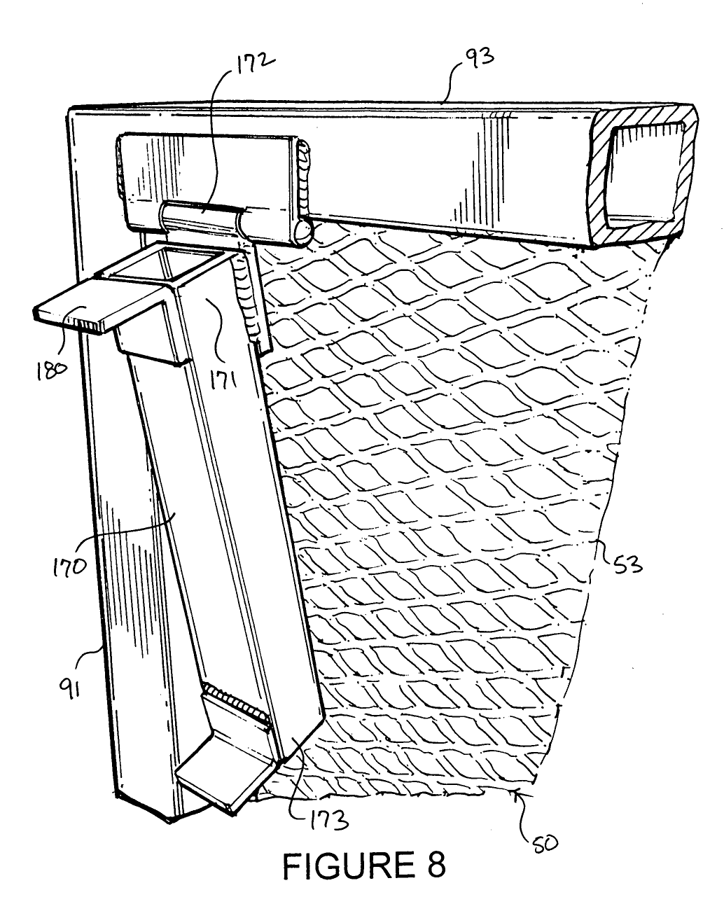

Abutment 161 provides structural support to front end 90 of platform at its outer side 93 in the lowered position of platform 51. To provide additional structural support to rear end 91 of platform 51 at its outer side 93 in the lowered position of platform 51, platform 51 incorporates an elongate support 170, which is depicted and referenced in FIGS. 3, 5, 7, and 8. Referring to FIG. 8, elongate support 170 is basically an elongate, rigid leg having a proximal end 171 pivotally attached to platform 51 at outer side 93 adjacent rear end 91 with a hinge 172, and an opposing distal end 173. In the raised position of platform 51, elongate support 170 pivots inwardly at hinge 172 relative to platform 51 hanging downwardly from outer side 93 being substantially horizontal relative to platform 51. In response to pivoting platform 51 to its lowered position, elongate support 170 pivots outwardly at hinge 172 relative to platform 51 as shown in FIG. 7 into its operative position being substantially perpendicular relative to platform 30 such that in the lowered position of platform 51 distal end 173 of elongate support 170 comes to rest against bed 30. In the lowered position of platform 51 as shown in FIG. 7, elongate support 170 is disposed between outer side 93 of platform 51 adjacent its rear end 91 and bed 30, in which proximal end 171 is attached to platform 51 and distal end 173 is positioned against bed 30 providing structural support to platform 51 in its lowered position. In response to movement of platform 51 from its lowered position to its raised position, elongate support 51 will pivot from its operative position to its stored position, in accordance with the principle of the invention. Although platform 51 incorporates only one elongate support 170, it can incorporate more if desired.

To provide platform 53 with structure that functions to dispose and support platform 53 in its lowered position, reference is directed to FIG. 3 in which it is seen that platform incorporates two elongate supports 170, in which one is mounted to outer end 113 adjacent front end 110 for there providing structural support for platform 53 in its lowered position, and the other is mounted to outer end 113 adjacent rear end 111 for there providing structural support for platform 53 in its lowered position. Elongate supports 170 incorporated with platform 53 are each completely analogous to elongate support 170 discussed in conjunction with platform 51, and the foregoing discussion of elongate support 170 in conjunction with platform 51 applies to each elongate support 170 in conjunction with platform 53. Although platform 53 incorporates two elongate supports 170, it can incorporate less or more depending on specific needs.

Platforms 52 and 54 can each incorporate one or more elongate supports if desired, much like that of platforms 51 and 53, if desired. In the preferred embodiment disclosed herein, however, it can be seen in FIG. 3 that proximal ends 171 of elongate supports 170 are each formed with an inwardly directed abutment/seat 180.

In the lowered positions of platform 51 and 53 as shown in FIG. 7 in which elongate supports 170 incorporated therewith are disposed in their operative positions as shown providing structural support for platforms 51 and 53 above bed 30, their abutments 180 project inwardly toward side 25 (not shown) of trailer 20. When platform 52 is moved into its lowered position as shown in FIG. 6, outer end 103 of platform 51 adjacent rear end 101 thereof comes to rest against abutment 180 of the elongate support 170 attached to platform 51 when platform 52 is laid into its lowered position providing structural support for platform 52 in its lowered position at outer end 103 of platform 52 adjacent its rear end 101, according to the principle of the invention. When platform 54 is moved into its lowered position as shown in FIGS. 5 and 6, outer end 123 of platform 54 adjacent front and rear ends 120 and 121 thereof come to rest against abutments 180 of the elongate supports 170 attached to platform 53 when platform 54 is laid into its lowered position providing structural support for platform 54 in its lowered position at outer end 123 of platform 54 adjacent its front and rear ends 120 and 121, according to the principle of the invention.

Those having regard for the art will readily appreciate that a highly useful trailer with platform assembly is disclosed. Platforms 51, 52, 53, and 54 can be selectively secured in their raised positions for increasing the size of storage area 34 and can be lowered relative to bed 30 of trailer onto which cargo may best set for transport, in which the storage spaces between platforms 51, 52, 53, and 54 and bed 30 may also be used for containing cargo. In the lowered position of platforms 51, 52, 53, and 54, trailer 20 essentially has a double-decker cargo supporting capability, in which bed 30 beneath platforms 51, 52, 53, and 54 and the storage space between platforms 51, 52, 53, and 54 provides one storage area in which cargo may be placed, and platforms 51, 52, 53, and 54 thereabove provide another storage area or cargo holding deck onto which cargo may be set.

As seen in FIG. 6, the invention also incorporates ramps 200, which are equal in size and equal in structure each having a hooked end 201 and an opposing end 202. Hooked ends 201 can be hooked onto platform assembly 50 and with their opposing ends 202 positioned on the ground ramps 200 can the be used to drive small vehicles, such as motorcycles and all-terrain-vehicles (ATVs) and the like, onto platforms 51, 52, 53, and 54 in their lowered positions. If desired, the outer sides 63 and 73 of side platforms 60 and 70, respectively, and/or the rear ends 111 and 121 of platforms 53 and 54 may each be configured with an upwardly projecting lip for allowing hooked ends 201 to be easily and securely hooked thereon. For illustrative purposes, FIG. 6 shows ramps 200 in phantom outline as they would appear associated with downstream end 23 of trailer 20 and hooked onto rear ends 111 and 121 of platforms 53 and 54, respectively. Ramps 200 can be hooked onto platform assembly 50 at any suitable locations.

As seen in FIGS. 3 and 4, downstream end 23 of trailer 20 is formed with opposed channels 210, in which one channel 210 is positioned at side 24 of trailer 20 and the other channel 210 is positioned at side 25 of trailer 20. Channels 210 are positioned alongside the opening into storage area. The ends 201 and 202 of ramps 200 are positionable into channels 210, respectively, and function to hold ramps 200 in place along downstream end 23 of trailer 20 enclosing the opening into storage space 34 at downstream end 23 of trailer 20.

Trailer 20 incorporates latches 220 as seen in FIGS. 3-6, which are used to secure ramps 200 in place in channels 210, in accordance with the principle of the invention. Latches 220 are identical and only one will be discussed with the understanding that the ensuing discussion applies to each of latches 220.

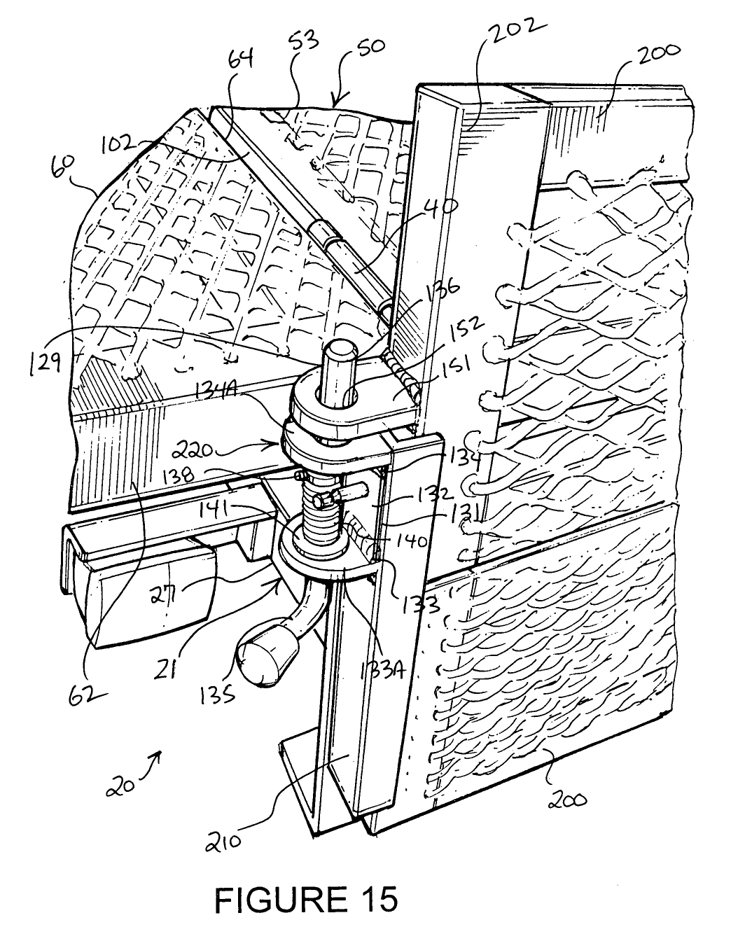

In common with latch 130 previously discussed, latch 220 shares bracket 131, pin 129 including its proximal and distal ends 135 and 136 and its intermediate portion 137 (not shown in FIG. 15) formed with abutment 138, spring 140 including its flanged ends 141 and 142, and support 151 including opening 152 therethrough. To secure ramps 200 to channels 210 their ends are situated therein, respectively, in which one ramp is positioned on edge atop the other ramp as shown in FIG. 15. Here end 202 of the upper one of ramps 200 is formed with support 151 having opening 152 that aligns with distal end 136 of pin 129 when this upper ramp 200 is situated in channels 210 atop the other of the ramps 200 previously positioned therein channels 210. Upon aligning the opening through support 151 with distal end 136 of pin 129 while in its cocked position, for instance, pin 129 may be released snapping pin 129 upwardly into its deployed position inserting distal end 136 of pin into and through the opening through support 151 affixed to end 202 of the upper ramp 200 securing/pinning the upper ramp 200 in place atop the lower ramp 200. Reversing this operation releases the upper ramp 200 allowing it to be easily removed.

In the preferred embodiment disclosed herein, bracket 131, to which pin 129 is attached, of latch 220 is secured to channel 210, and support 151 is secured to end 202 of the upper ramp 200, and this arrangement can be reversed, if desired. It is to be understood that the hooked end 201 of the upper ramp 200 shown in FIG. 15 is also configured, along with its corresponding channel 210, with the same form of latch 220.

The invention has been described above with reference to a preferred embodiment. However, those skilled in the art will recognize that changes and modifications may be made to the embodiment without departing from the nature and scope of the invention. The various latches herein disclosed in conjunction with trailer 20 and platform assembly 50 are set forth for illustrative purposes and are preferred insofar as they are easy to constructed and inexpensive. Those having regard for the art will readily appreciate that any suitable latch in which opposed parts engage to secure objects together can be used without departing from the invention, including any latch having a bar, pin, bolt or the like that falls into a notch, opening, receiving area, or the like.

Also, platforms 51, 52, 53, and 54 may be configured with any suitable form of hold-down or tie-down hardware or features for securing cargo, much like side platforms 60 and 70. Moreover, platforms 51, 52, 53, and 54 may be provided with handles, if desired, for use in maneuvering them between their raised and lowered positions. As a matter of example of this aspect, FIG. 18 shown handles 225 and 226 affixed to platforms 53 and 54 at outer ends 113 and 123 adjacent their rear ends 111 and 121, respectively. More handles can be used, if desired, and handles incorporated with platforms 51, 52, 53, and 54 can be positioned onto them anywhere.

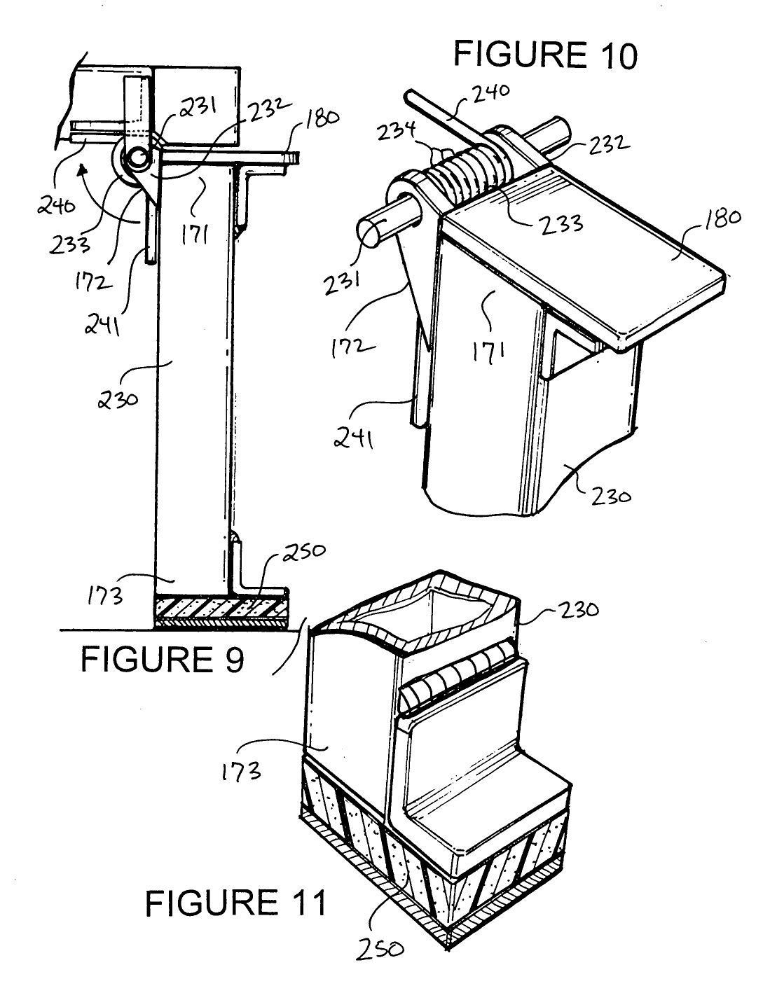

Also, reference is now made to FIG. 11, which illustrates an alternate embodiment of an elongate support 230. Elongate support 230 is completely analogous to each elongate support 170 previously discussed sharing proximal and distal ends 171 and 173 and hinge 172. In this embodiment of elongate support 230, and with reference to FIG. 10, hinge 172 incorporates a pin 231 that extends through a bracket 232. A tension spring 233 is shown which includes a wire formed into coils 234 encircling pin 231 between bracket 232. The ends of tension spring 233 lead to opposed tag ends 240 and 241, in which one tag end 240 is disposed to interact with a platform and the other tag end 241 is disposed to interact with elongate support 230 biasing it in its operative position. In the raised position of a platform incorporating elongate support 230, the tension supplied by spring 233 is insufficient to overcome the weight of elongate support 230 so that it will assume its stored position. In response to movement of the platform incorporating elongate support 230 into its lowered position, the tag ends 240 and 241 of spring 233 interacting with the platform and elongate support 230 bias elongate support 230 into its operative position, in accordance with the principle of the invention. Consistent with the teachings of the invention, any suitable spring form may be used for applying the described bias to an elongate support incorporated with a platform of a platform assembly constructed and arranged in accordance with the principle of the invention. As seen in FIGS. 9 and 11, distal end 173 of elongate support 230 is configured with an attached pad 150, which provides a cushion between distal end 173 of elongate support 230 and the bed against which it is set.

Various further changes and modifications will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Apparatus comprising:
a trailer including a bed; and
a first platform mounted to the trailer for pivotal movement at an elevated location relative to the bed between a raised position upright relative to the bed and a lowered position spaced from, opposing, and parallel relative to the bed;
wherein in its lowered position the first platform forms a first auxiliary load-bearing bed spaced from and overlying the bed of the trailer.

2. Apparatus according to claim 1, further comprising a second platform mounted to the trailer for pivotal movement at an elevated location relative to the bed between a raised position upright relative to the bed and a lowered position spaced from, opposing, and parallel relative to the bed, wherein in its lowered position the second platform forms a second auxiliary load-bearing bed spaced from and overlying the bed of the trailer.

3. Apparatus according to claim 2, further comprising in their lowered positions the first and second platforms together form a third auxiliary load-bearing bed spaced from and overlying the bed of the trailer, which is greater in size than each of the first and second auxiliary load-bearing beds.

4. Apparatus according to claim 3, wherein the third auxiliary load-bearing bed formed by the first and second platforms in their lowered positions extends longitudinally of the trailer substantially from the upstream end to the downstream end.

5. Apparatus according to claim 3, wherein the third auxiliary load-bearing bed formed by the first and second platforms in their lowered positions extends transversely of the trailer substantially from the first side to the second side.

6. Apparatus according to claim 2, further comprising a first latch mounted to the trailer for securing the first platform in its raised position.

7. Apparatus according to claim 2, further comprising a first abutment carried by the trailer for supporting the first platform in its lowered position.

8. Apparatus according to claim 2, further comprising a first elongate support having a proximal end secured to the first platform and a distal end positioned against the bed in the lowered position of the first platform supporting the first platform in its lowered position.

9. Apparatus according to claim 2, further comprising a second latch mounted to one of the first platform and the trailer for supporting the second platform in its raised position.

10. Apparatus according to claim 2, further comprising a second abutment carried by one of the second platform and the trailer for supporting the second platform in its lowered position.

11. Apparatus according to claim 2, further comprising a second elongate support having a proximal end secured to the second platform and a distal end positioned against the bed in the lowered position of the second platform supporting the second platform in its lowered position.

12. Apparatus according to claim 8, wherein the first elongate support is pivotally secured to the first platform, and movable between a first position toward the first platform in its raised position and a second position away from first platform in its lowered position.

13. Apparatus according to claim 10, further comprising a bias applied to the first elongate support biasing the first elongate support toward its second position.

14. Apparatus according to claim 8, wherein the second elongate support is pivotally secured to the second platform, and movable between a first position toward the second platform in its raised position and a second position away from second platform in its lowered position.

15. Apparatus according to claim 14, further comprising a bias applied to the second elongate support biasing the second elongate support toward its second position.

16. Apparatus comprising:
a trailer including a bed;
a first platform mounted to the trailer for pivotal movement at an elevated location relative to the bed between a raised position upright relative to the bed and a lowered position spaced from, opposing, and parallel relative to the bed;
in its lowered position the first platform forming a first auxiliary load-bearing bed spaced from and overlying the bed of the trailer.
a second platform mounted to the trailer for pivotal movement at an elevated location relative to the bed between a raised position upright relative to the bed and a lowered position spaced from, opposing, and parallel relative to the bed,
in its lowered position the second platform forming a second auxiliary load-bearing bed spaced from and overlying the bed of the trailer; and
in their lowered positions the first and second platforms together forming a third auxiliary load-bearing bed spaced from and overlying the bed of the trailer, which is greater in size than each of the first and second auxiliary load-bearing beds.

17. Apparatus according to claim 16, wherein the third auxiliary load-bearing bed formed by the first and second platforms in their lowered positions extends longitudinally of the trailer substantially from the upstream end to the downstream end.

18. Apparatus according to claim 16, wherein the third auxiliary load-bearing bed formed by the first and second platforms in their lowered positions extends transversely of the trailer substantially from the first side to the second side.

19. Apparatus according to claim 16, further comprising a first latch mounted to the trailer for securing the first platform in its raised position.

20. Apparatus according to claim 16, further comprising a first abutment carried by the trailer for supporting the first platform in its lowered position.

21. Apparatus according to claim 16, further comprising a first elongate support having a proximal end secured to the first platform and a distal end positioned against the bed in the lowered position of the first platform supporting the first platform in its lowered position.

22. Apparatus according to claim 16, further comprising a second latch mounted to one of the first platform and the trailer for supporting the second platform in its raised position.

23. Apparatus according to claim 16, further comprising a second abutment carried by one of the second platform and the trailer for supporting the second platform in its lowered position.

24. Apparatus according to claim 16, further comprising a second elongate support having a proximal end secured to the second platform and a distal end positioned against the bed in the lowered position of the second platform supporting the second platform in its lowered position.

25. Apparatus according to claim 21, wherein the first elongate support is pivotally secured to the first platform, and movable between a first position toward the first platform in its raised position and a second position away from first platform in its lowered position.

26. Apparatus according to claim 25, further comprising a bias applied to the first elongate support biasing the first elongate support toward its second position.

27. Apparatus according to claim 24, wherein the second elongate support is pivotally secured to the second platform, and movable between a first position toward the second platform in its raised position and a second position away from second platform in its lowered position.

28. Apparatus according to claim 27, further comprising a bias applied to the second elongate support biasing the second elongate support toward its second position.
